(19) United States
(12) Patent Application Publication
(10) Pub. No.: US 2006/0218612 A1
(43) Pub. Date: Sep. 28, 2006

(54) Fault detection and isolation system for an HFC cable network and method therefor

(76) Inventors: Keith Johnson, San Antonio, TX (US); Amol Mandlekar, Austin, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 11/069,156

(22) Filed: Mar. 1, 2005

(51) Int. Cl. H04N 7/173

(52) U.S. Cl. 725/107

(57) ABSTRACT

A fault detection and isolation system for an HFC cable network and method therefore. A ping list generator captures set top box (STB) identifying information from a billing system, and STB state information from a network control system. The ping list generator creates a ping list from the STB identifying information and the STB state information, wherein the list comprises the IP address of a set of the addressable STBs connected to an HFC cable network. In an exemplary embodiment, the set is of sufficient size to be representative of the health of the HFC cable network. In another embodiment of the present invention, the set comprises substantially all of the addressable STBs connected to the HFC cable network. A ping generator, pings the IP address of the STB and awaits a response. If the response is received from the STB, then identify the STB as responsive. If the response is not received, then identify the STB as non-responsive. A fault isolation processor associates the STB identifying information and the ping response, determines whether a non-responsive fault indicator is present, and, if the fault indicator is present, then identifies a likely cause of the non-responsive fault.

### BACKGROUND

Embodiments of the present invention are directed generally to cable network fault isolation and more specifically to the identification of faults in devices comprising the cable plant.

Cable networks deliver voice, data, and video to subscribers over a complex network of headends, regional data centers, hubs, and nodes. At the upstream terminus of the network is the headend and regional data center. Typically, a head end comprises the analog and digital video signal processors, video on demand systems, and other video content management devices. A regional data center comprises digital service management devices (e-mail servers, DNS, and Internet connectivity) and routers that interconnect the regional data center with a headend. A hub receives the video and data signals from the headend and regional data center, processes these signals through appropriate modulators, and sends these signals downstream to a hub. The hub provides the signals to a node that is ultimately associated with individual subscribers. A node provides an interface between the fiber-based component of the HFC cable network and the RF/cable component of the network that is the transport media to the home.

In a commercial network, a headend may service multiple hubs and a hub may service multiple nodes. A regional data center may provide digital services to multiple headends. From a node to the home, the RF/cable component of the HFC cable network may branch numerous times. Amplifiers, line extenders, and passive devices are employed to maintain signal quality across all branches (or “cascades”) serviced by the node.

FIG. 1 illustrates typical prior art cable system architecture. A headend 100 comprises a network control system 102 that handles set-top provisioning, system management and interactive session set-up, a video signal processor 104 that handles content acquisition and delivery, 256 QAM Modulators 111 that generate modulated RF streams of digital video signals, a high speed data interface 106, and a billing system 107.

Headend 100 communicates with hub 108. Hub 108 comprises a cable modem termination system 110, a 256 QAM modulator 112 for downstream data traffic, a QPSK modulator for downstream Out-of-Band Data traffic 114, and a QPSK demodulator 116 for upstream Out-of-Band Data traffic. As will be appreciated by those skilled in the art, a hub may comprise multiple instances of each device illustrated in FIG. 1.

Hub 108 communicates with nodes 120A, 120B and 120C. Nodes 120 provide an interface between the fiber-based transport medium of the cable network (between the headend 100 and upstream side of nodes 110) and the coax-based medium (between the downstream side of nodes 110 and the subscriber interface 145). The downstream side of node 110B is further illustrated as connecting to bridger amplifier 1 125 which in turn is connected to bridger amplifier 2 130. The serial path from node 120B through bridger amplifier 1 125 to bridger amplifier 2 130 is referred to as a cascade relative to node 120B. Bridger amplifier 1 125 has three branches that are cascades relative to bridger amplifier 1 125 and sub-cascades relative to node 120B.

As will be appreciated by those skilled in the art, FIG. 1 is a greatly simplified schematic of cable network architecture. A hub typically serves 20,000 subscribers. A typical hub supports from 50 to 100 nodes with each node capable of serving 250 to 2000 subscribers. In order to maintain signal quality and quality of service commitments, trunk amplifiers maintain high signal quality. Internal bridger modules in the trunk amplifiers boost signals for delivery to subscribers' homes. Line Extender amplifiers maintain the high signal levels in cascade after the trunk amplifiers, through the neighborhoods. Taps divide out small amounts of signal for connection to the homes. Nominal cascade limits are up to 4 trunk amplifiers followed by up to 3 line extenders, with more in very rural areas. In suburban areas, cascades typically comprise 2 trunk and 2 line extenders. Because branching is unlimited, the total device count per node may be large despite short cascades.

At the downstream end of the network is the customer premises equipment (CPE). Referring again to FIG. 1, subscriber interface 145 connects a set top box (STB) 150 and a cable modem (CM) 155 to the HFC cable network. The CPE receives content from a headend or regional data center and provides access to it by a subscriber. For example, video programming is delivered to STB 150 and high speed data services are delivered to CM 155.

The complexity of cable networks makes network fault isolation and maintenance a challenging task. The task can be partitioned into four stages:

determining that a failure has occurred;

determining what has failed;

determining where in the network the failure is likely to be; and

determining that a network is imminently approaching failure.

A failure in any of the system components that provide services will ultimately cause subscribers to complain. However, relying on subscriber complaints to identify network faults is not only bad for business but, in many situations, too imprecise to be helpful. Further, customer complaints represent the existence of a problem rather than forecast that a problem is developing. Reliance on such data alone for network fault isolation and maintenance precludes proactive responses by the cable operator.

What would be useful is a system and method that provides a cable operator with information indicative of the existence of a problem on the cable network and is helpful in isolating the source of that problem.

### SUMMARY

Cable networks have evolved from downstream broadcast systems provided over coax cable to hybrid fiber cable (HFC) networks capable of both downstream and upstream communications using both analog and digital signals. With respect to video services, modern set top boxes send upstream signals to the headend to request video on demand (VOD) services, pay per view (PPV) services, and switched video broadcast (SVB) services and to issue control commands (play, stop, fast forward, rewind, and pause) that affect the video stream. Two-way STBs are addressable, can be associated with a subscriber, and can be associated with a physical location with an HFC cable network. As will be appreciated by those skilled in the art, an STB may be either a standalone device or incorporated into a cable-ready television. Additionally, a STB may be adapted such that the security and access functions are performed by an external PCMCIA-type card. See, OpenCable™ Multistream CableCARD Interface Specification OC-SP-MC-IF-I02-040831.

An exemplary embodiment of the present invention provides a method for “pinging” a set of the addressable STBs connected to an HFC cable network, wherein the set is of sufficient size to be representative of the health of the HFC cable network or regional or logical subset thereof. In another embodiment of the present invention, the set comprises substantially all of the addressable STBs connected to the HFC cable network. As used herein, the verb “ping” means the act of using the ping utility or command. The ping utility sends a packet to a device with an IP address. As used herein, an IP address means a uniquely addressable identifier associated with network or home equipment capable of responding to a ping. The ping utility waits for a response. The response is indicative that the device received the ping-packet, that the device is present on the network, and that the path to the device is functional.

A functioning STB that receives the ping will respond with an acknowledgement. An STB that does not respond to the ping may be non-responsive because the STB is not connected to the HFC cable network, because the STB is not functioning properly, because that STB is not currently registered with the HFC cable network, or because some aspect of the HFC cable network is not functioning properly. In the exemplary embodiment, the ping is sent to all STBs connected to the HFC cable network. Responses to the ping are analyzed to determine whether faults in the HFC cable network have occurred and, if so, where in the network architecture the fault is likely to be.

In this exemplary embodiment, the STBs are pinged once per hour, however this is not meant as a limitation. The cable operator may choose the pinging rate. As will be appreciated by those skilled in the art, the pinging rate represents a balance between the desire for diagnostic information regarding the state of the HFC cable network and the desire to avoid placing demands on network resources that compete with subscribers' use of the network for revenue generating services.

In the exemplary embodiment, billing information is used to associate an STB with a subscriber location and with a particular hub, demodulator, and node on the HFC cable network. In yet another embodiment of the present invention, an STB is further associated with a specific bridger amplifier and line extender. By analyzing the results of the ping across all of the STBs connected to the HFC cable network, the performance of a hub, demodulator and node can be assessed. The ping data can be used to confirm the operation of the HFC cable network from the node upstream and to allow isolation of a detected fault downstream.

In yet another embodiment of the present invention, STBs are polled. The verb “poll” means the act of using a utility or command by one network device to request data from another network device. In this embodiment, an STB is polled for its current reverse data carrier (RDC) level. High RDC levels are indicative of noise on the upstream and/or problems with equipment that support the upstream of the HFC cable network.

It is therefore an aspect of the present invention to facilitate the identification and isolation of faults in an HFC cable network.

It is another aspect of the present invention to provide fault detection and isolation with minimal disruption to the provision of subscriber services.

It is yet another aspect of the present invention to distinguish between faults in a hub and those in a node of an HFC cable network.

It is still another aspect of the present invention to distinguish between faults in particular modulators or demodulators within a hub.

It is an aspect of the present invention to distinguish between faults on the fiber side of an HFC cable network and those on the RF/coax side of an HFC cable network.

It is another aspect of the present invention to assess the effect of changes in network and STB operating systems on overall network performance.

It is still another aspect of the present invention to acquire RDC levels of STBs.

It is yet another aspect of the present invention to use RDC level statistics to forecast network problems and to schedule proactive maintenance of network components.

It is another aspect of the present invention to identify STB reverse data carrier (RDC) performance by model and manufacturer.

These and other aspects of the present invention will become apparent from the general and detailed description that follows.

Embodiments of the present invention are directed to identifying and isolating faults in an HDC cable network using data obtained from the addressable STBs connected to the HDC cable network. In an application entitled, “An Early Warning Fault Identification And Isolation System For A Two-Way Cable Network,” filed concurrently with the present application, embodiments are directed to identifying and isoloating faults in an HDC cable network using data acquired from pinging selected STBs. The application entitled “An Early Warning Fault Identification And Isolation System For A Two-Way Cable Network” is incorporated herein by reference in its entirety for all purposes. A system and method for determining what has failed and where in the network the failure is likely to be found was described in U.S. patent application Ser. No. 11/040,391 filed on Jan. 21, 2005 and entitled, “A Fault Isolation System And Method,” The Ser. No. 11/040,391 Application is incorporated herein by reference in its entirety for all purposes.

In an embodiment of the present invention, an HFC cable network comprises a plurality of set top boxes (STBs) and a fault detection and isolation system comprises a ping list generator, a ping generator, and a fault isolation processor. The ping list generator creates a ping list comprising assigned IP addresses of the plurality of addressable set top boxes (STBs) connected to the HFC cable network. In an embodiment of the present invention, the plurality of addressable STBs is of sufficient size to be representative of the health of the HFC cable network. In another embodiment of the present invention, the plurality of addressable STBs comprises substantially all of the addressable STBs connected to the HFC cable network.

In an embodiment of the present invention, the ping list generator captures set top box (STB) identifying information from a billing system and STB state information from a network control system. The ping list is created from the STB identifying information and the STB state information.

In yet another embodiment of the present invention, STB identifying information is selected from the group consisting of an STB IP address, an STB serial number, an STB manufacturer, an STB MAC address, a node associated with the STB, a modulator associated with the STB and the hub, a demodulator associated with the STB and the hub, a power supply associated with the node, an amplifier associated with the STB, a line extender associated with the STB, a customer account number, a customer account status, a customer address, and a customer phone number. In another embodiment of the present invention, the STB state information is selected from the group consisting of an IP address of the STB as determined by a network control system, a node associated with the STB as determined by the network control system, a modulator associated with the STB and the hub as determined by a network control system, a demodulator associated with the STB and the hub as determined by a network control system.

The ping generator pings an assigned IP address on the ping list and awaits a response. If the response is received from the STB, then STB operational status is set as responsive. If the response is not received, then STB operational status is set as non-responsive.

In another embodiment of the present invention, the ping generator comprises a parent ping script. The parent ping script creates a sublist from the ping list. In this embodiment, the sublist comprises assigned IP addresses of a subset of the plurality of addressable STBs connected to the HFC cable network. The ping generator assigns the sublist to a child script, which pings the STB IP addresses on the sublst and waits for responses. The responses are collected and the child script is provided another sublist.

Based on the STB operational status, the fault isolation processor determines whether a fault indicator indicative of a network fault is present. If the fault indicator is present, then a likely cause of the network fault is determined.

In an embodiment of the present invention, the fault isolation processor associates the STB operational status with a node, the node with a demodulator, and the demodulator with a hub. The fault isolation processor establishes a node minimum responsiveness measure expressed as ratio of STBs associated with the node that responded to the ping to the total number of STBs associated with the node that were pinged. The fault indicator comprises a failure of the node to meet or exceed the node minimum responsive measure.

In an yet another embodiment of the present invention, the fault isolation processor establishes a demodulator minimum responsiveness measure expressed as ratio of STBs associated with the demodulator that responded to the ping to the total number of STBs associated with the demodulator that were pinged. The fault indicator comprises a failure of the demodulator to meet or exceed the demodulator minimum responsive measure.

In an yet another embodiment of the present invention, the fault isolation processor establishes a hub minimum responsiveness measure expressed as ratio of STBs associated with the hub that responded to the ping to the total number of STBs associated with the hub that were pinged. The fault indicator comprises a failure of the hub to meet or exceed the hub minimum responsive measure.

In yet another embodiment of the present invention, the demodulator is associated with a first and second node. The fault isolation processor determines whether the first node meets or exceeds the node minimum responsiveness measure. If the first node does not meet or exceed the node minimum responsiveness measure, then fault isolation processor determines whether a second node meets or exceeds the node minimum responsiveness measure. If the second node meets or exceeds the node minimum responsiveness measure, then the fault isolation processor identifies the likely cause of the network fault as a failure of the first node. If the second node does not meet or exceed the minimum responsiveness measure, then the fault isolation processor identifies the likely cause of the network fault as a failure of the demodulator.

In yet another embodiment of the present invention, the hub is associated with a first and second demodulator. The fault isolation processor determines whether the first demodulator meets or exceeds the demodulator minimum responsiveness measure. If the first demodulator does not meet or exceed the demodulator minimum responsiveness measure, the fault isolation processor determines whether the second demodulator meets or exceeds the demodulator minimum responsiveness measure. If the second demodulator meets or exceeds the demodulator minimum responsiveness measure, the fault isolation processor identifies the likely cause of the network fault as a failure of a network segment emanating downstream from the first demodulator. If the second demodulator does not meet or exceed the demodulator minimum responsiveness measure, the fault isolation processor identifies the likely cause of the network fault as a failure of the hub.

In an embodiment of the present invention, the STB further comprises manufacturer identifying information associating the STB with the name of a manufacturer, with a model number, and with an STB release number. If the fault indicator is present, the fault isolation processor determines whether the likely cause of the network fault is the STBs of the manufacturer based on the operational status of the STBs of the manufacturer.

In another embodiment of the present invention, the system further comprises a polling generator. The polling generator polls a responsive STB for a reverse data carrier (RDC) level. The RDC level is stored in a polling data file. The fault isolation processor establishes an RDC responsiveness measure expressed as a maximum average of the RDC level of each STB associated with the hub and determines whether the RDC responsiveness measure has been exceeded. If the RDC responsiveness measure has been exceeded, network segments upstream from the STBs are evaluated for network faults.

In yet another embodiment of the present invention, the polling data file comprises a manufacturer of the STB. The fault isolation processor determined the average RDC level of STBs of each manufacturer associated with the hub and whether the average RDC level of STBs of a manufacturer exceed the RDC responsiveness measure. If the average RDC level of STBs of the manufacturer exceeds the RDC responsiveness measure, remedial action with respect to the STBs of the manufacturer is taken.

In an embodiment of the present invention, an HFC cable network comprises a plurality of set top boxes (STBs). This embodiment provides a method of detecting a fault in a hybrid fiber coax (HFC) cable network. A ping list comprising an assigned IP addresses of the plurality of addressable set top boxes (STBs) connected to the HFC cable network is created. An assigned IP address on the ping list is pinged. If a response is received from the STB, an STB operational status is set to “responsive.” If the response is not received, the STB operational status is set to “non-responsive.” A determination is made whether a fault indicator indicative of a network fault is present. If the fault indicator is present, then a likely cause of the network fault is identified and remedial action to correct the likely cause is taken.

In an embodiment of the present invention, the set top box (STB) identifying information is captured from a billing system and STB state information is captured from a network control system. The ping list is created from the STB identifying information and the STB state information.

In an embodiment of the present invention a sublist is created from the ping list. In this embodiment, the sublist comprises assigned IP addresses of a subset of the plurality of addressable STBs connected to the HFC cable network. The sublist is assigned to a child script, which to pings the STB IP addresses on the sublist and waits for responses. The responses are collected and the child script is provided another sublist.

### DESCRIPTION OF THE DRAWINGS

FIG. 1 illustrates typical cable system architecture.

FIG. 2 illustrates a block diagram of high-level components of a HFC cable network fault detection and isolation system according to an embodiment of the present invention.

FIG. 3 illustrates a flow of a process by which set top boxes are pinged and polled according to an embodiment of the present invention.

### DETAIL DESCRIPTION

The following terms are used in the description that follows. The definitions are provided for clarity of understanding:

| | |
|---|---|
| Bridger | Trunk/Bridger amplifiers amplify and reamplify cable |
| Amplifier - | signals for transmission through a cable television trunk |
| | system and out to the distribution system. They provide the |
| | interface between the trunk and distribution systems. Also |
| | called a bridger or a trunk/bridger amplifier. |
| Cascade - | A serial path extending from an active device. |
| CM - | Cable modem. |
| CPE - | Customer premises equipment. |
| Fork - | The verb “to fork” means the act of one or more instances |
| | of a segment of code within a script and executing each |
| | instance independent of the others. The original script is a |
| | “parent” and each instance is a “child.” The parent |
| | continues to execute while each child is executing. |
| HFC - | Hybrid Fiber Coax. A network design that employs both |
| | fiber optic and coaxial cables to deliver cable video and |
| | data services. |
| Hub - | The local source of cable services. By way of illustration |
| | and not as a limitation, a hub may serve 20,000 subscribers. |
| IP | IP address as used herein means a uniquely addressable |
| address - | identifier associated with network or home equipment |
| | capable of responding to a ping. |
| Line | An amplifier that reamplifies the signal from the |
| extender - | Trunk/Bridger amplifier. Taps that provide the cable |
| | connections to the homes are installed in the distribution |
| | cabling between the Trunk/Bridger amplifiers and the line |
| | extenders. |
| Node - | A device that provides an interface between the fiber optic |
| | and coaxial cable systems of an HFC cable system. Light |
| | from a fiber optic cable is converted into an electrical |
| | signal suitable for delivery in a coaxial cable system within |
| | this device. |
| Ping - | The verb “to ping” means the act of using the ping utility or |
| | command. The ping utility sends a packet to a device with |
| | an IP address and waits for a response. The response is |
| | indicative that the ping packet was received by the device |
| | and the device is present on the network. The noun “ping” |
| | means the request for a response from a network device. |
| Poll - | The verb “poll” means the act of using a utility or |
| | command by one network device to request data from |
| | another network device. |
| RDC level - | Reverse data carrier level. A measure of the signal strength |
| | of the upstream signal generated by an STB or other CPE |
| | device. |
| STB - | Set top box. |
| Tap - | A passive device that divides out small amounts of signal |
| | for connection to the homes. They typically have 2, 4 or 8 |
| | ports for connection of drop cables. |

Cable networks have evolved from downstream broadcast systems provided over coax cable to hybrid fiber cable (HFC) networks capable of both downstream and upstream communications using both analog and digital signals. With respect to video services, modern set top boxes send upstream signals to the headend to request video on demand (VOD) services pay per view (PPV) services, and switched video broadcast (SVB) services and to issue control commands (play, stop, fast forward, rewind, and pause) that affect the video stream. Two-way STBs are addressable, can be associated with a subscriber, and can be associated with a physical location with an HFC cable network.

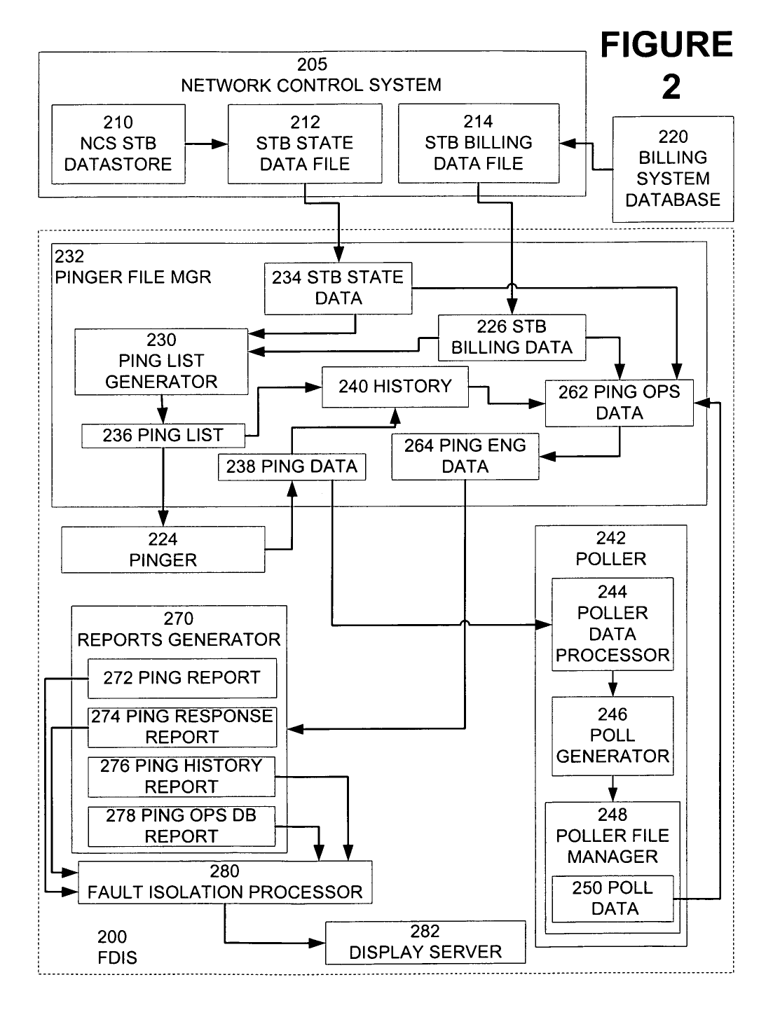

FIG. 2 illustrates a block diagram of high-level components of a HFC cable network fault detection and isolation system (FDIS) according to an embodiment of the present invention. Referring to FIG. 2, HFC cable network fault detection and isolation system (FDIS) 200 comprises pinger 224, pinger file manager 232, poller 242, datastore 260, reports generator 270, fault isolation processor 280, and display server 282. Network control system (NCS) 205 comprises NCS STB datastore 210, STB state data file 212, and STB billing data file 214. While these elements are illustrated as components of NCS 205, this is not meant as a limitation. As will be appreciated by those skilled in the art, the elements of NCS 205 and FDIS 200 may be located in other components of the HFC cable network without departing from the scope of the present invention.

Pinger 224 comprises instructions that “ping” devices. Poller 242 comprises instructions that “poll” devices. As used herein, the verb “to ping” means the act of using the ping utility or command. The ping utility sends a packet to a device with an IP address. As used herein, an IP address means a uniquely addressable identifier associated with network or home equipment capable of responding to a ping. The ping utility waits for a response. The response is indicative that the ping packet was received by the device and the device is present on the network. The noun “ping” means the request for a response from a network device. By contrast, as used herein, the verb “poll” means the act of using a utility or command by one network device to request data from another network device. By way of illustration and not as a limitation, embodiments of the present invention poll an STB for its current reverse data carrier level.

In an embodiment of the present invention, the billing system database 220 sends data relating to STBs as assigned to customer accounts to STB billing data file 214. By way of illustration and not as a limitation, STB-related data comprises STB serial number, STB MAC address, node, power supply, amplifier, and line extender information, customer account number, customer account status, customer address, and customer phone number. In an exemplary embodiment, the data is sent everyday so as to reflect additions and deletions to the pool of STBs.

NCS 205 queries the NCS STB datastore 210 to capture state changes in STBs since the STB data was last received by the NCS STB datastore 210. The results are saved in an STB state data file 212. In another embodiment of the present invention, STB state data file 212 also receives an STB MAC location file that associates STB MAC addresses with the physical address of the subscriber. The STB MAC location file facilitates the association of an STB with a particular hub and QPSK demodulator.

Pinger file manager 232 comprises ping list generator 230, STB state data file 234, STB billing data 226, ping list file 236, ping data file 238, history file 240, ping operations data file 262 and ping engineering data file 264. Ping operations data file 262 is generated from the STB billing data file 226, the STB state data file 234, the history file 240 and the poll data file 250 (described below). In an embodiment of the present invention, for each STB supported by NCS 205, ping operations data file 262 comprises the STB serial number; STB MAC address; a hub, a demodulator, a node, a power supply, an amp, and a line extender associated with the STB; customer account number, customer account status (active, de-activated), customer address, customer phone number associated with the STB; the ping response and ping response history of the STB; and a reverse data carrier (RDC) level (described below) of the STB. In another embodiment of the present invention, ping engineering data file 264 comprises a subset of ping operations data file 262 in which the customer account information has been removed.

In an embodiment of the present invention, ping list generator 230 acquires data from STB state data file 234 and the STB billing data file 226 and processes the acquired data to produce ping list 236. In an embodiment of the present invention, the ping list comprises a set of the addressable STBs connected to an HFC cable network, wherein the set is of sufficient size to be representative of the health of the HFC cable network or regional or logical subset thereof. In an embodiment of the present invention, the set comprises substantially all of the addressable STBs connected to the HFC cable network. Ping list file 236 identifies STBs that have IP addresses and comprises the most current ping results for each STB listed. The results of the last ping of the STBs listed in ping file list 236 are stored in ping data file 238. Ping data is also saved for a fixed number of ping cycles in history file 240.

Pinger 224 accesses the ping list, pings the listed STBs and reports the results to ping data file 238. In an embodiment of the present invention, an STB that responds to a ping is identified as “responsive” and an STB that does not respond to the ping is described to be “non-responsive.” The ping results are also saved to history file 240. In an embodiment of the present invention, history file 240 comprises ping data for a fixed number of ping cycles. In this embodiment, when the history file is updated, the first ping data entry for an STB is deleted and the most recent ping data entry is added.

In an embodiment of the present invention, the STB state data file 212, the STB billing data file 214, the STB billing data file 226, the STB state data file 234, and the ping list file 236 are created according to a schedule. By way of illustration and not as a limitation, the STB state data file 212 and the STB billing data file 214 are created once each day. The STB billing data file 226 and the STB state data file 234 are created once each day after the creation of the STB state data file 212 and the STB billing file data 214. The ping list file 236 is created each hour from the STB data file.

Additionally, once each day and following the update of the STB state data 234, the history file 240 is updated. If an STB that has been added to the STB data file 234, a new entry is made to the STB history file 238 and the ping number is set to zero. If an STB has been removed from the STB data file 234, the STB history entry for that STB is removed from STB history file 238.

In an embodiment of the present invention, pinger 224 uses a forking script to ping STBs simultaneously. The forking script comprises a “parent” and a predetermined number of copies of a code segment within the parent each referred to as a “child” and collectively referred to as “children.” The parent creates sub-lists from ping list 236 and assigns a sub-list to each child. The children operate simultaneously to ping the STBs on their respective sub-lists. Each child executes its ping sub-list, captures the data in a file, and then exits. The parent then creates another child to maintain the predetermined number of children and assigns another ping sub-list to the new child. The data files created by each child are combined to form ping data file 238.

Poller 242 comprises poller data processor 244, poll generator 246, and poller file manager 248. Poller data processor 244 reads ping data 238 from pinger file manager 232 and captures the IP address of each STB and the ping result of that STB. If the ping result of an STB is “responsive,” then the data is provided to poll generator 246 and a poll for that STB is generated and the STB is polled for a reverse data carrier (RDC) level. If the ping result of an STB is “non-responsive,” no poll is generated for that STB. The results of a poll are sent to poll file manager 248 and stored in poll data file 250.

Ping engineering data file 264 is accessed by reports generator 270. Reports generator 270 creates ping report 272 and ping response 274 for both the last ping and poll cycle. Using history file 240, reports generator 270 further creates ping history report 276 and ping history response 278. Ping history report 276 and ping operations database report 278 cover the number of ping and poll cycles that determine the extent of history file 240.

In an embodiment of the present invention, a ping report 272 comprises:
the number of STBs recognized by the NCS 205 by STB MAC address;
the number of STBs identified by the billing system database 220 as having been assigned to subscribers;
the number of homes served currently receiving digital services associated with NCS 205. It should be noted that the number of homes receiving digital services may be less than the number of homes served by the NCS.
the number of STBs that have been assigned IP addresses;
of all of the STBs that were assigned IP addresses and that were pinged, how many responded in the last hour;
of all of the STBs that were assigned IP addresses and that were pinged, how many responded 100% of the time;
of all of the STBs that were assigned IP addresses and that were pinged, how many never responded;
expected STB configuration as reflected in the billing system database 220; and
the hub, modulator and demodulator associated with each STB.

In an embodiment of the present invention, a ping response report 272 records the response in association with each hub, demodulator, and node in the HFC network serviced by NCS 205. This report comprises ping responses received relative to the pings sent at the hub level, the demodulator level and the node level. For example, in an embodiment of the present invention, the report:

h 1000 982 of 1031, d 1000.1 247 of 278, n 1012 67 of 93,

indicates that the response for hub 1000 was 982 responses for 1031 pings, that response for demodulator 1 in hub 1000 was 247 responses for 278 pings, and the response for node 1012 associated with hub 1 was 67 responses for 93 pings. As will be appreciated by those skilled in the art, other report formats may be used without departing from the scope of the present invention.

In an embodiment of the present invention, ping history report 276 relates the history of a specific STB by its IP address. In an embodiment of the present invention, ping history report 276 comprises the information reflected in ping report 272 extended over the number of ping cycles that define the period of history file 240.

In an embodiment of the present invention, ping operations database report 278 comprises information associated with a STB. By way of illustration and not as a limitation, ping operations database report 278 comprises the STB serial number, MAC address, IP address, modulator-id, demodulator-id, node, on-account (or not), active (not shut off due to non-payment), set for 2-way, whether NCS 205 considers the STB as 2-way, a 10-day response history of the STB, a last hour ping status, customer account number, a customer telephone number, and a customer address.

In an embodiment of the present invention, ping history response 276 comprises the information reflected in ping response 274 extended over the number of ping cycles that define the period of history file 240.

Ping report 272, ping response 274, ping history report 276, and ping operations database report 278 are read by fault isolation processor 280, which produces strings that are used by display server 282 to produce graphical displays of the ping and poll results.

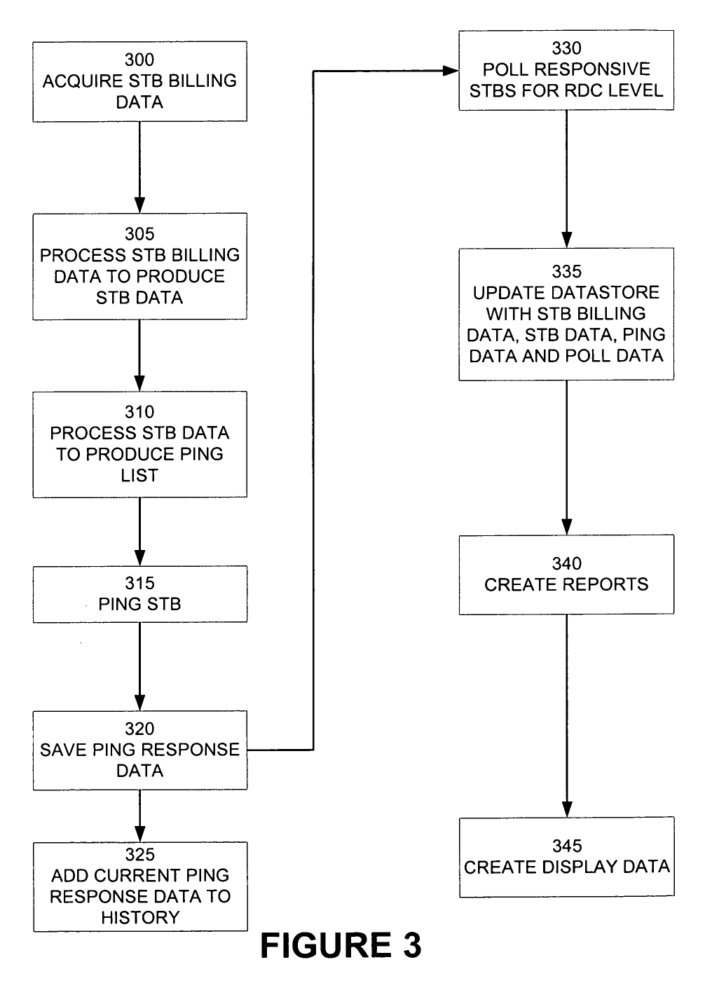

FIG. 3 illustrates a flow of a process by which set top boxes are pinged and polled according to an embodiment of the present invention. As used herein, the verb “to ping” means the act of using the ping utility or command. The ping utility sends a packet to a device with an IP address and waits for a response. The response is indicative that the ping packet was received by the device and the device is present on the network. The noun “ping” means the request for a response from a network device. By contrast, as used herein, the verb “poll” means the act of using a utility or command by one network device to request data from another network device. By way of illustration and not as a limitation, embodiments of the present invention poll an STB for its current reverse data carrier level.

Referring to FIG. 3, STB billing data is acquired 300. The STB billing data is processed to produce STB data 305. According to an embodiment of the present invention, STB data comprises an STB IP address, an STB MAC address, a modulator identifier and a demodulator identifier. The STB data is then processed to produce a ping list 310. In an embodiment of the present invention, the ping list comprises STBs that have IP addresses and their most current ping statistics.

The STBs on the ping list are pinged 315 and the responses stored in a ping data file 320. In an embodiment of the present invention, a ping generator uses a forking script to ping STBs simultaneously. The forking script comprises a “parent” and a predetermined number of copies of a code segment within the parent each referred to as a “child” and collectively referred to as “children.” The parent creates sub-lists from the ping list and assigns a sub-list to each child. The children operate simultaneously to ping the STBs on their respective sub-lists. Each child executes its ping sub-list, captures the data in a file, and then exits. The parent then creates another child to maintain the predetermined number of children and assigns another ping sub-list to the new child. The data files created by each child are combined to form the ping data file.

The ping response data are used to update a ping history file 325. The responses are also used to poll responsive STBs for the STB reverse data carrier (RDC) level 330. The results of the poll are combined with the STB billing data, STB data, and ping data to update files in a datastore 335. These data are then used to produce reports 340 and display data 345.

The ping responses from STBs may be used to both detect and isolate a fault in the HFC cable network. Ping data may be analyzed using numerous methods to indicate and isolate faults. Viewing node responses averaged over 10 days will pinpoint nodes that statistically fail to perform at as high a level as other nodes. Maintenance efforts may then be focused on the low responding nodes to improve their performance. The ping operations database report 278 can be loaded into a spreadsheet for sorting by node, bridger, line-extender, and/or power-supply and checked to see if there is a common active device associated with a large number of non-responding STBs. Non-response can be looked at from a STB make, model, revision standpoint to see if a particular type stands out statistically from others as having higher incidences of communication problems. It is possible to parse persistent data per hub, demodulator, or node for a given period of time to analyze performance over large periods of time to see problematic segments of the network.

RDC levels received by demodulators can be analyzed to see if any segments of the reverse network have too much attenuation or noise that are driving up reverse carrier levels. Additionally, by looking at graphs or displays of the previous hours ping results it can be detected if a network component fails that removes large segments of the network. In an embodiment of the present invention, an average RDC level greater than 40-45 dbmV is indicative of a problem on the RF/cable side of the HFC cable network.

In an embodiment of the present invention, both ping responses and RDC levels are associated with STBs of a manufacturer and, optionally, a model and release number of a manufacturer. In this way, the behavior of particular STB products can be evaluated.

A failure of a significant number of STBs associated with a node to respond may be indicative of a problem with the RF/coax plant of that node. Because the physical location of each STB is known from the STB billing data, ping response data is analyzed to determine if the non-responsive STBs are clustered and associated with an amplifier or line extender.

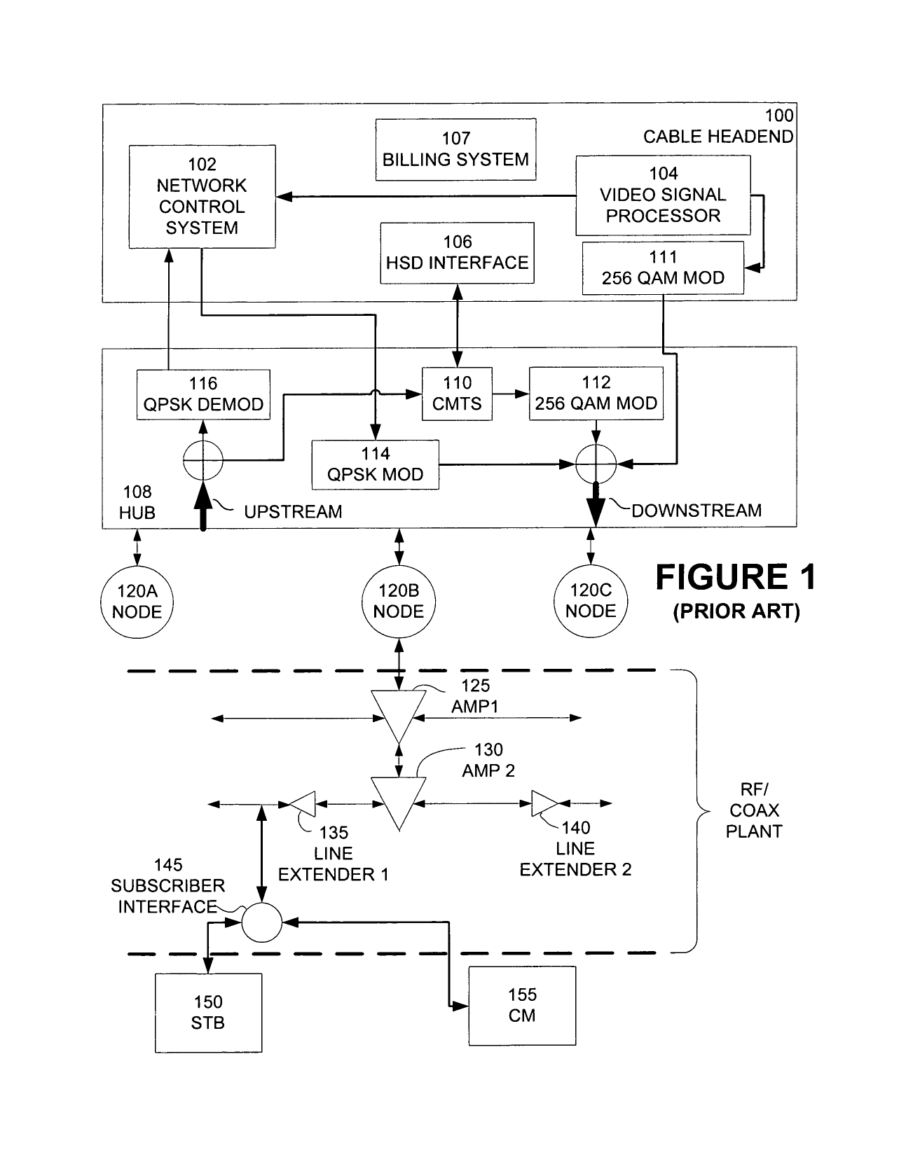

In an embodiment of the present invention, the ping process is extended to cable modems. Referring again to FIG. 1, cable modem billing information is acquired from the billing system and a ping list is created. The cable modem 155 is pinged and the response noted. A response from cable modem 155 associated with hub 108 indicates that the 256 QAM modulator 112 associated with the CMTS 110 and QPSK or QAM demodulator 116 are operative. A response from cable modem 155 also indicates that node 120B is operating. If STBs associated with node 120B and hub 108 are not responding, then the problem may be in QPSK modulator 114.

A fault detection and isolation system for an HFC cable network and method therefor have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A fault detection and isolation system for a hybrid fiber coax (HFC) cable network, wherein the HFC cable network comprises a plurality of set top boxes (STBs) and the system comprises:
a ping list generator, wherein the ping list generator is adapted to create a ping list comprising assigned IP addresses of the plurality of addressable set top boxes (STBS) connected to the HFC cable network;
a ping generator, wherein the ping generator is adapted to:
ping an assigned IP address on the ping list and await a response;
if the response is received from the STB, then set an STB operational status as responsive; and
if the response is not received, then set the STB operational status as non-responsive; and
a fault isolation processor is adapted to:
based on the STB operational status, determine whether a fault indicator indicative of a network fault is present; and
if the fault indicator is present, then identify a likely cause of the network fault.

2. The system of claim 1, wherein the ping list generator is further adapted to:
capture set top box (STB) identifying information from a billing system;
capture STB state information from a network control system; and
create the ping list from the STB identifying information and the STB state information.

3. The system of claim 2, wherein STB identifying information is selected from the group consisting of an STB IP address, an STB serial number, an STB manufacturer, an STB MAC address, a node associated with the STB, a modulator associated with the STB and the hub, a demodulator associated with the STB and the hub, a power supply associated with the node, an amplifier associated with the STB, a line extender associated with the STB, a customer account number, a customer account status, a customer address, and a customer phone number.

4. The system of claim 2, wherein the STB state information is selected from the group consisting of an IP address of the STB as determined by a network control system, a node associated with the STB as determined by the network control system, a modulator associated with the STB and the hub as determined by a network control system, a demodulator associated with the STB and the hub as determined by a network control system.

5. The system of claim 1, wherein the plurality of addressable STBs is of sufficient size to be representative of the health of the HFC cable network.

6. The system of claim 1, wherein the plurality of addressable STBs comprises substantially all of the addressable STBs connected to the HFC cable network.

7. The system of claim 1, wherein the ping generator further comprises a parent ping script adapted to:
create a sublist from the ping list, wherein the sublist comprises assigned IP addresses of a subset of the plurality of addressable STBs connected to the HFC cable network;
assign the sublist to a child script, wherein the child script is adapted to ping the STB IP addresses on the sublst and wait for responses;
collect responses; and
provide the child script another sublist.

8. The system of claim 1, wherein the fault isolation processor is further adapted to:
associate the STB operational status with a node;
associate the node with a demodulator; and
associate the demodulator with a hub.

9. The system of claim 8, wherein the fault isolation processor is further adapted to:
establish a node minimum responsiveness measure expressed as ratio of STBs associated with the node that responded to the ping to the total number of STBs associated with the node that were pinged; and
wherein the fault indicator comprises a failure of the node to meet or exceed the node minimum responsive measure.

10. The system of claim 8, wherein the fault isolation processor is further adapted to:
establish a demodulator minimum responsiveness measure expressed as ratio of STBs associated with the demodulator that responded to the ping to the total number of STBs associated with demodulator that were pinged;
and wherein the fault indicator comprises a failure of the demodulator to meet or exceed the demodulator minimum responsive measure.

11. The system of claim 8, wherein the fault isolation processor is further adapted to:
establish a hub minimum responsiveness measure expressed as ratio of STBs associated with the hub that responded to the ping to the total number of STBs associated with hub that were pinged;
and wherein the fault indicator comprises a failure of the hub to meet or exceed the hub minimum responsive measure.

12. The system of claim 9, wherein the demodulator is associated with a first and second node, and the fault isolation processor is further adapted to:
determine whether the first node meets or exceeds the node minimum responsiveness measure;
if the first node does not meet or exceed the node minimum responsiveness measure, then determine whether a second node meets or exceeds the node minimum responsiveness measure;
if the second node meets or exceeds the node minimum responsiveness measure, then identify the likely cause of the network fault as a failure of the first node; and
if the second node does not meet or exceed the minimum responsiveness measure, then identify the likely cause of the network fault as a failure of the demodulator.

13. The system of claim 10, wherein the hub is associated with a first and second demodulator, and the fault isolation processor is further adapted to:
determine whether the first demodulator meets or exceeds the demodulator minimum responsiveness measure;
if the first demodulator does not meet or exceed the demodulator minimum responsiveness measure, then determine whether the second demodulator meets or exceeds the demodulator minimum responsiveness measure;
if the second demodulator meets or exceeds the demodulator minimum responsiveness measure, then identify the likely cause of the network fault as a failure of a network segment emanating downstream from the first demodulator; and
if the second demodulator does not meet or exceed the demodulator minimum responsiveness measure, then identify the likely cause of the network fault as a failure of the hub.

14. The system of claim 1, wherein the STB further comprises manufacturer identifying information associating the STB with a manufacturer, and wherein the fault isolation processor is further adapted to, if the fault indicator is present, determine whether the likely cause of the network fault is the STBs of the manufacturer based on the operational status of the STBs of the manufacturer.

15. The system of claim 14, wherein the manufacturer identifying information comprises a manufacturer's name.

16. The system of claim 15, wherein the manufacturer identifying information further comprises an STB model number.

17. The system of claim 16, wherein the manufacturer identifying information further comprises an STB release number.

18. The system of claim 8 further comprising a polling generator adapted to:
poll a responsive STB for a reverse data carrier (RDC) level;
store the RDC level in a polling data file; and
wherein the fault isolation processor is further adapted to:
establish an RDC responsiveness measure expressed as an maximum average of the RDC level of each STB associated with the hub;
determine whether the RDC responsiveness measure has been exceeded; and
if the RDC responsiveness measure has been exceeded, then evaluate network segments upstream from the STBs for network faults.

19. The system of claim 18, further comprising:
wherein the polling data file further comprises a manufacturer of the STB and wherein the fault isolation processor is further adapted to:
determine an average RDC level of STBs of each manufacturer associated with the hub;
determine whether the average RDC level of STBs of a manufacturer exceed the RDC responsiveness measure; and
if the average RDC level of STBs of the manufacturer exceeds the RDC responsiveness measure, then take remedial action with respect to the STBs of the manufacturer.

20. A method of detecting a fault in a hybrid fiber coax (HFC) cable network wherein the HFC cable network comprises a plurality of addressable set top boxes (STBs) and the method comprises:
creating a ping list comprising an assigned IP addresses of the plurality of addressable set top boxes (STBs) connected to the HFC cable network;
pinging an assigned IP address on the ping list and awaiting a response;
if the response is received from the STB, then setting an STB operational status as responsive; and
if the response is not received, then setting the STB operational status as non-responsive;
determining whether a fault indicator indicative of a network fault is present; and
if the fault indicator is present, then identifying a likely cause of the network fault and taking remedial action to correct the likely cause.

21. The method of detecting a fault in an HFC cable network of claim 20, wherein creating a ping list comprises:
capturing set top box (STB) identifying information from a billing system;
capturing STB state information from a network control system; and
creating the ping list from the STB identifying information and the STB state information.

22. The method of detecting a fault in an HFC cable network of claim 21, wherein STB identifying information is selected from the group consisting of an STB IP address, an STB serial number, an STB manufacturer, an STB MAC address, a node associated with the STB, a modulator associated with the STB and the hub, a demodulator associated with the STB and the hub, a power supply associated with the node, an amplifier associated with the STB, a line extender associated with the STB, a customer account number, a customer account status, a customer address, and a customer phone number.

23. The method of detecting a fault in an HFC cable network of claim 21, wherein the STB state information is selected from the group consisting of an IP address of the STB as determined by a network control system, a node associated with the STB as determined by the network control system, a modulator associated with the STB and the hub as determined by a network control system, a demodulator associated with the STB and the hub as determined by a network control system.

24. The method of detecting a fault in an HFC cable network of claim 20, wherein the plurality of addressable STBs is of sufficient size to be representative of the health of the HFC cable network.

25. The method of detecting a fault in an HFC cable network of claim 20, wherein the plurality of addressable STBs comprises substantially all of the addressable STBs connected to the HFC cable network.

26. The method of detecting a fault in an HFC cable network of claim 20, wherein the method further comprises:
creating a sublist from the ping list, wherein the sublist comprises a subset of a set of STB IP addresses on the ping list;
assigning the sublist to a child script, wherein the child script is adapted to ping the STB IP addresses on the sublist and wait for responses;
collecting responses; and
providing the child script another sublist.

27. The method of detecting a fault in an HFC cable network of claim 20, further comprising:
associating the STB operational status with a node;
associating the node with a demodulator; and
associating the demodulator with a hub.

28. The method of detecting a fault in an HFC cable network of claim 27 further comprising establishing a node minimum responsiveness measure expressed as ratio of STBs associated with the node that responded to the ping to the total number of STBs associated with the node that were pinged; and wherein determining whether the fault indicator indicative of a network fault is present comprises determining whether the node meets or exceeds the node minimum responsive measure.

29. The method of detecting a fault in an HFC cable network of claim 27 further comprising establishing a demodulator minimum responsiveness measure expressed as ratio of STBs associated with the demodulator that responded to the ping to the total number of STBs associated with demodulator that were pinged; and wherein determining whether the fault indicator indicative of a network fault is present comprises determining whether the demodulator meets or exceeds the demodulator minimum responsive measure.

30. The method of detecting a fault in an HFC cable network of claim 27 further comprising establishing a hub minimum responsiveness measure expressed as ratio of STBs associated with the hub that responded to the ping to the total number of STBs associated with hub that were pinged, and wherein determining whether the fault indicator indicative of a network fault is present comprises determining whether the hub meets or exceeds the hub minimum responsive measure.

31. The method of detecting a fault in an HFC cable network of claim 28, wherein a demodulator is associated with a first and second node, and the method further comprises:
determining whether the first node meets or exceeds the node minimum responsiveness measure;
if the first node does not meet or exceed the node minimum responsiveness measure, then determining whether a second node meets or exceeds the node minimum responsiveness measure;
if the second node meets or exceeds the node minimum responsiveness measure, then identifying the likely cause of the network fault as a failure of the first node; and
if the second node does not meet or exceed the minimum responsiveness measure, then identifying the likely cause of the network fault as a failure of the demodulator.

32. The method of detecting a fault in an HFC cable network of claim 29, wherein a hub is associated with a first and second demodulator, and the method further comprises:
determining whether the first demodulation meets or exceeds the demodulator minimum responsiveness measure;
if the first demodulator does not meet or exceed the demodulator minimum responsiveness, then determining whether the second demodulator meets or exceeds the demodulator minimum responsiveness measure;
if the second demodulator meets or exceeds the demodulator minimum responsiveness measure, then identifying the likely cause of the network fault as a failure of a network segment emanating downstream from the first demodulator; and
if the second demodulator does not meet or exceed the demodulator minimum responsiveness measure, then identifying the likely cause of the network fault as a failure of the hub.
